(19) United States
(12) Patent Application Publication
(10) Pub. No.: US 2013/0223554 A1
(43) Pub. Date: Aug. 29, 2013

(54) SPATIAL MULTIPLEXING COMMUNICATION SYSTEM AND METHOD

(71) Applicant: Electronics and Telecommunications Research Institute, (US)

(72) Inventors: Seung Eun HONG, Daejeon (KR); Jin Kyeong KIM, Daejeon (KR); Hyun Kyu CHUNG, Daejeon (KR)

(73) Assignee: Electronics and Telecommunications Research Institute, Daejeon (KR)

(21) Appl. No.: 13/778,200

(22) Filed: Feb. 27, 2013

(30) Foreign Application Priority Data
Feb. 27, 2012 (KR) 10-2012-0019566

(51) Int. Cl. H04B 7/04

(52) U.S. Cl. CPC H04B 7/0413
USPC 375/267

(57) ABSTRACT

Provided is a communication system for transmitting data using a plurality of interference-free communication channels. A transmission apparatus may inactivate a portion from among a plurality of transmit antennas and thereby group transmit antennas into a plurality of antenna groups. A channel formed between each antenna group and a reception apparatus may have a relatively low correlation and thus, the may be assumed to be independent. Accordingly, the transmission apparatus and the reception apparatus may transmit data using separate interference-free communication channels.

### CROSS-REFERENCE TO RELATED APPLICATION

This application claims the priority benefit of Korean Patent Application No. 10-2012-0019566, filed on Feb. 27, 2012, in the Korean Intellectual Property Office, the disclosure of which is incorporated herein by reference.

### BACKGROUND

1. Field of the Invention

The present invention relates to a multiple input multiple output (MIMO) communication system and method for transmitting data using a plurality of antennas, and more particularly, to a communication system and method for transmitting data using a plurality of interference-free communication channels.

2. Description of the Related Art

Multiple antennas are generally employed in a wireless and mobile communication field. When the multiple antennas are employed, a plurality of transmission paths that is utilizing the same time and the same frequency and is also spatially separable from each other may be generated. Accordingly, when the multiple antennas are employed, an amount of signals transmittable using the same power may be increased.

Currently, millimeter wave communication systems based on a frequency band of 60 GHz have been developed. Millimeter wave communication technology may be employed as competitive wireless link configuration technology capable of providing a wired transmission rate using an optic cable. A millimeter wave communication system may provide a transmission rate of a few bit per second (bps) through use of a wireless wideband channel. However, due to propagation characteristics of millimeter waves that high pathloss occurs, even though beamforming technology using multiple antennas is employed, the millimeter wave communication system may provide a communication distance of around 10 m.

To overcome the above disadvantages, research on a spatial multiplexing scheme using multiple antennas has been conducted. In the case of millimeter wave communication in the frequency band of 60 GHz that requires beamforming technology, a line of sight (LOS) channel may be formed through beamforming. Accordingly, the spatial multiplexing scheme has been generally considered to be difficult to be applied.

### SUMMARY

An aspect of exemplary embodiments provides a new spatial multiplexing scheme using beamforming.

An aspect of exemplary embodiments also provides a spatial multiplexing scheme that may transmit data using interference-free communication channels.

An aspect of exemplary embodiments also provides a reception method of a spatial multiplexing scheme that may decode a transmission signal using simple calculation.

According to an aspect of exemplary embodiments, there is provided an operation method of a transmission apparatus, the method including: selecting a portion from among a plurality of activated transmit antennas, inactivating the selected transmit antennas, and grouping unselected activated transmit antennas into a plurality of groups; and transmitting data to a reception apparatus by individually beamforming each of the plurality of groups.

The operation method of the transmission apparatus may further include estimating a distance between the transmission apparatus and the reception apparatus.

The grouping may include selecting the portion from among the plurality of activated transmit antennas based on the distance.

The operation method of the transmission apparatus may further include receiving, from the reception apparatus, a rank of a channel formed between each of the plurality of groups and the reception apparatus. The transmitting may include transmitting the data based on the rank.

The transmitting may include transmitting, to the reception apparatus, the number of data streams less than or equal to the rank.

The selected transmit antennas may be adjacent to each other.

The operation method of the transmission apparatus may further include transmitting, to the reception apparatus, group information that includes the number of groups and the number of transmit antennas that are included in each of the plurality of groups. The transmitting may include transmitting the data based on the group information.

According to another aspect of exemplary embodiments, there is provided an operation method of a transmission apparatus, the method including: selecting a portion of consecutive transmit antennas from among a plurality of transmit antennas, and inactivating the selected consecutive transmit antennas; grouping unselected transmit antennas into a plurality of groups; and forming a beam corresponding to each of the plurality of groups using transmit antennas that are included in a corresponding group, and transmitting data to a reception apparatus using the formed beam.

The operation method of the transmission apparatus may further include: transmitting a training signal to the reception apparatus using the formed beam; receiving a feedback about the training signal; and determining whether to transmit the data using the formed beam, based on the feedback.

The operation method of the transmission apparatus may further include transmitting, to the reception apparatus, information about the beam determined to be used to transmit the data, when the data is determined to be transmitted using the formed beam. Information about the beam determined to be used to transmit the data may be used to form a reception beam for receiving the data.

The operation method of the transmission apparatus may further include: estimating a distance between the transmission apparatus and the reception apparatus; and determining the number of transmit antennas to be selected based on the distance.

According to still another aspect of exemplary embodiments, there is provided an operation method of a reception apparatus, the method including: receiving a training signal that is beam formed and thereby transmitted from each of a plurality of antenna groups, the plurality of antenna groups being generated by inactivating a portion of transmit antennas selected from among a plurality of transmit antennas installed in a transmission apparatus; transmitting a feedback about the training signal to the transmission apparatus; and receiving, from the transmission apparatus, data that is transmitted using a transmission beam, the transmission beam being determined based on the feedback.

The selected transmit antennas may be consecutively aligned.

The operation method of the reception apparatus may further include: estimating a channel formed between each of the plurality of antenna groups and the reception apparatus with respect to the transmission beam that is determined based on the feedback; and transmitting information about the estimated channel to the transmission apparatus. The receiving may include receiving the data based on information about the channel.

Information about the channel may include a rank of a channel matrix that is generated using the estimated channel. The receiving may include receiving, from the transmission apparatus, the number of data streams less than or equal to the rank.

The operation method of the reception apparatus may further include: receiving information about the transmission beam that is formed based on the feedback; and forming a reception beam based on information about the transmission beam. The receiving may include receiving the data using the formed reception beam.

The transmitting may be performed in parallel with respect to each of the plurality of antenna groups.

The transmitting may be sequentially performed with respect to each of the plurality of antenna groups.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a spatial multiplexing communication system using multiple antennas according to a related art;

FIG. 2 is a diagram illustrating a process of inactivating and thereby grouping a portion of antennas according to an exemplary embodiment;

FIG. 3 is a block diagram illustrating a configuration of signal processing for forming a spatial multiplexing multiple input multiple output (MIMO) channel according to an exemplary embodiment;

FIG. 4 is a flowchart illustrating an operation method of a transmission apparatus according to an exemplary embodiment;

FIG. 5 is a flowchart illustrating an operation method of a transmission apparatus according to another exemplary embodiment; and

FIG. 6 is a flowchart illustrating a reception method of a reception apparatus according to an exemplary embodiment.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

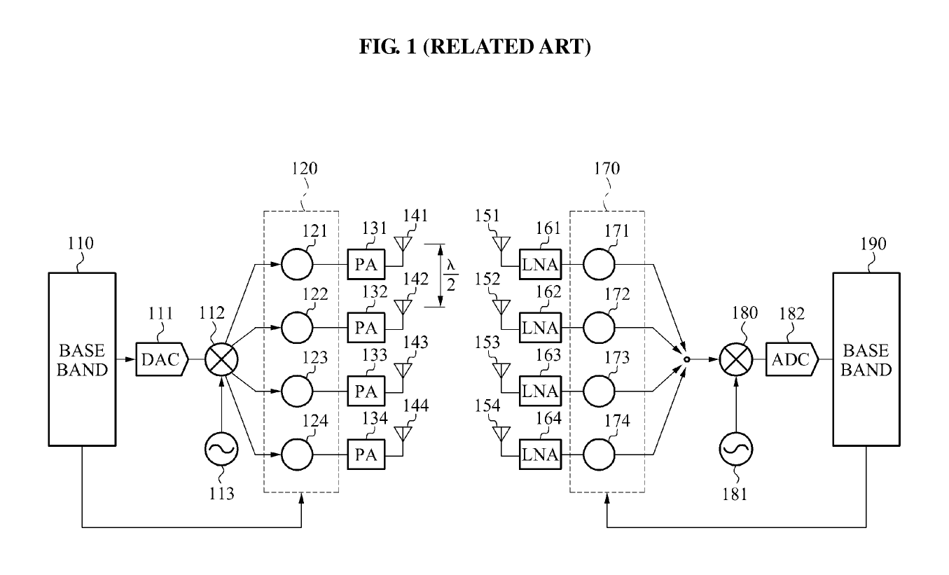

FIG. 1 is a diagram illustrating a spatial multiplexing communication system using multiple antennas according to a related art.

A baseband 110 may configure a baseband signal to be transmitted to a reception apparatus. A digital-to-analog converter (DAC) 111 may convert the baseband signal to an analog signal. The converted analog signal may be modulated to a carrier frequency by a frequency generator 113 and to a high frequency signal by a frequency modulator 112.

The modulated high frequency signal may be beam formed by a beamforming apparatus 120. The beamforming apparatus 120 may form a transmission beam by multiplying the high frequency signal and a weight vector using weight multipliers 121, 122, 123, and 124.

Power amplifiers (PAs) 131, 132, 133, and 134 may amplify the high frequency signal multiplied by the weight vector. The amplified high frequency signal may be transmitted using transmit antennas 141, 142, 143, and 144.

The transmit antennas 141, 142, 143, and 144 may be aligned to be spaced apart from each other at intervals corresponding to at least a half of a wavelength of the carrier frequency. When the carrier frequency being used is 30 GHz to 300 GHz, the wavelength of the carrier frequency corresponds to a few millimeters and thus, the transmit antennas 141, 142, 143, and 144 may be aligned to be spaced apart from each other at intervals corresponding to a few millimeters. A size of an antenna system may be significantly reduced.

The reception apparatus may receive a high frequency signal using receive antennas 151, 152, 153, and 154, and may amplify the high frequency signal using low noise amplifiers (LNAs) 161, 162, 163, and 164 corresponding to the respective receive antennas 151, 152, 153, and 154. A beamforming apparatus 170 of the reception apparatus may form a reception beam by multiplying the high frequency signal and a weight vector using weight multipliers 171, 172, 173, and 174.

A frequency generator 181 may generate a carrier frequency. Using the generated carrier frequency, a frequency demodulator 180 may demodulate the high frequency signal to a baseband signal. An analog-to-digital converter (ADC) 182 may convert the demodulated baseband signal to a digital signal, and a baseband 190 may decode a signal transmitted from the transmission apparatus by processing the digital signal.

FIG. 1 shows an embodiment in which both the transmission apparatus and the reception apparatus transmit and receive a signal using a beam. In the case of utilizing beamforming, it is possible to transmit a signal to a further distance. However, a signal may be concentrated on a predetermined direction and thereby transmitted and thus, it is difficult to form a plurality of transmission paths spatially separable from each other. Accordingly, to increase a transmission capacity, a relatively wide bandwidth or a high order modulation and demodulation scheme may need to be employed. However, in this case, signal processing rates of the DAC 111 and the ADC 182 need to be increased and thus, the configuration may become difficult.

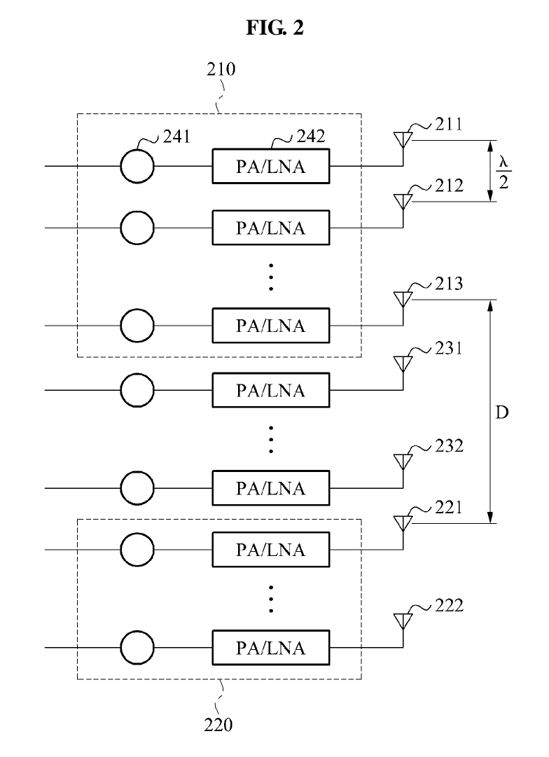

FIG. 2 is a diagram illustrating a process of inactivating and thereby grouping a portion of antennas according to an exemplary embodiment. Even though antennas of FIG. 2 correspond to transmit antennas installed in a transmission apparatus, grouping may also be performed by applying a similar method to receive antennas installed in a reception apparatus.

Referring to FIG. 2, the transmission apparatus may include a plurality of transmit antennas 211, 212, 213, 231, 232, 221, and 222. Each of the transmit antennas 211, 212, 213, 231, 232, 221, and 222 may include a weight multiplier 241 and a PA 242. In a case where the embodiment of FIG. 2 relates to the reception apparatus, the transmit antennas 211, 212, 213, 231, 232, 221, and 222 may be replaced with receive antennas, and the PA 242 may be replaced with an LNA.

According to an aspect, the transmit antennas 211, 212, 213, 231, 232, 221, and 222 installed in the transmission apparatus may be spaced apart from each other at intervals corresponding to at least a half of a wavelength of a carrier frequency, that is, more than λ/2.

According to an aspect, the transmission apparatus may select a portion of transmit antennas, for example, the transmit antennas 231 and 232 from among the transmit antennas 211, 212, 213, 231, 232, 221, and 222, and may not select the remaining transmit antennas 211, 212, 213, 221, and 222.

The transmission apparatus may inactivate the selected transmit antennas 231 and 232, and may activate the unselected transmit antennas 211, 212, 213, 221, and 222. Also, the transmission apparatus may group the unselected transmit antennas 211, 212, 213, 221, and 222 into a first antenna group 210 and a second antenna group 220.

According to an aspect, the selected transmit antennas 231 and 232 may be consecutive antennas. In this case, each of the first antenna group 210 and the second antenna group 220 may be spaced apart from each other to be in proportion to the number of selected transmit antennas.

According to an aspect, the transmission apparatus may estimate a distance between the transmission apparatus and the reception apparatus, and may select a transmit antenna based on the estimated distance. For example, when the distance between the transmission apparatus and the reception apparatus is R, a distance D between the first antenna group 210 and the second antenna group 220 may be determined according to Equation 1:

D=sqrt(Rλ/N) [Equation 1]

In Equation 1, D denotes the distance between the respective antenna groups, R denotes the distance between the transmission apparatus and the reception apparatus, λ denotes a wavelength of a carrier frequency transmitted and received using a transmit antenna, and N denotes the number of transmit antennas that are included in each antenna group.

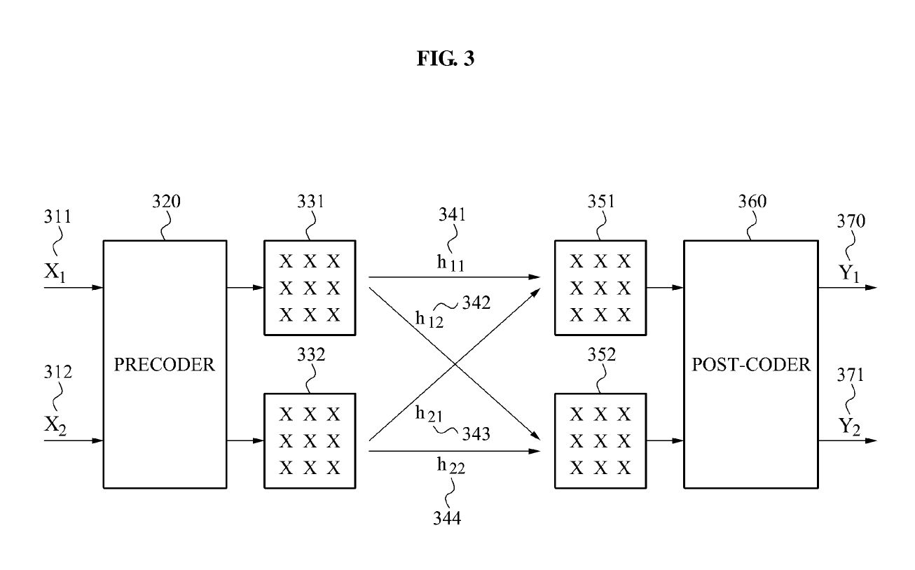

FIG. 3 is a block diagram illustrating a configuration of signal processing for forming a spatial multiplexing MIMO channel according to an exemplary embodiment.

Even though each of a transmission apparatus and a reception apparatus uses two antenna groups in the embodiment of FIG. 3, the transmission apparatus or the reception apparatus according to another embodiment may also operate using at least three antenna groups.

According to an aspect, the transmission apparatus and the reception apparatus of FIG. 3 may form a plurality of transmission channels between the respective antenna groups. When each of the transmission apparatus and the reception apparatus uses two antenna groups, four transmission channels 341, 342, 343, and 344 may be formed.

A precoder 320 of the transmission apparatus may precode a plurality of data streams 311 and 312. The precoder 320 may perform precoding by multiplying the plurality of data streams 311 and 312 by a weight vector.

A precoded data stream may be transmitted to the reception apparatus using each of transmit antenna groups 331 and 332. Each of the transmit antenna groups 331 and 332 may form a corresponding transmission beam and may transmit a data stream using the formed transmission beam.

The reception apparatus may receive the data streams using receive antenna groups 351 and 352. According to an aspect, each of the receive antenna groups 351 and 352 may form a corresponding reception beam and may receive a data stream using the formed reception beam.

A post-coder 360 may perform post-coding by multiplying the received data stream by a second weight vector.

When the transmission apparatus and the reception apparatus transmit and receive data using four transmission channels 341, 342, 343, and 344, the data received by the reception apparatus may be expressed by Equation 2:

$$[ \begin{matrix}{y}_{1} \\ {y}_{2}\end{matrix} ] = [ \begin{matrix}{h}_{11} & {h}_{12} \\ {h}_{21} & {h}_{22}\end{matrix} ] [ \begin{matrix}{x}_{1} \\ {x}_{2}\end{matrix} ] or y = H \cdot x \qquad [ Equation 2 ]$$

In Equation 2, a vector y denotes a reception vector received by the reception apparatus and a size of the vector y is identical to the number of receive antennas included in each of the receive antenna groups 351 and 352. A vector x denotes a transmission vector including a bitstream to be transmitted by the transmission apparatus, and a size of the vector x is identical to the number of transmit antennas included in each of the transmit antenna groups 331 and 332. A matrix H denotes a channel matrix that uses, as an element, a channel state of a channel formed between the respective antenna groups. For example, h₁₁ denotes a channel state of a channel formed between the transmit antenna group 331 to the receive antenna group 351, h₁₂ denotes a channel state of a channel formed between the transmit antenna group 331 and the receive antenna group 352, h₂₁ denotes a channel state of a channel formed between the transmit antenna group 331 and the receive antenna group 352, and h₂₂ denotes a channel state of a channel formed between the transmit antenna group 332 and the receive antenna group 352.

According to an aspect, the transmission apparatus and the reception apparatus may generate a transmit antenna group and a receive antenna group, respectively, so that interference may not affect between the respective channels. For example, even though a channel formed between the transmit antenna group 331 and the receive antenna group 351 is present, a channel formed between the transmit antenna group 331 and the receive antenna group 352 may be absent. Also, even though a channel formed between the transmit antenna group 332 and the receive antenna group 352 is present, a channel formed between the transmit antenna group 332 and the receive antenna group 351 may be absent.

In this case, Equation 2 may be simplified as given by Equation 3:

$$[ \begin{matrix}{y}_{1} \\ {y}_{2}\end{matrix} ] = [ \begin{matrix}{d}_{1} & 0 \\ 0 & {d}_{2}\end{matrix} ] [ \begin{matrix}{x}_{1} \\ {x}_{2}\end{matrix} ] + [ \begin{matrix}{n}_{1} \\ {n}_{2}\end{matrix} ] or y = D \cdot x + n \qquad [ Equation 3 ]$$

In Equation 3, d1 denotes a channel state of a channel formed between the transmit antenna group 331 and the receive antenna group 351, and d2 denotes a channel state of a channel formed between the transmit antenna group 332 and the receive antenna group 352.

When the channel matrix H is expressed as a diagonal matrix D that expresses independent channels as shown in Equation 3, a plurality of data streams may be transmitted without be affected by interference. Since the plurality of data streams may be simultaneously transmitted, capacity of a wireless channel may be maximized.

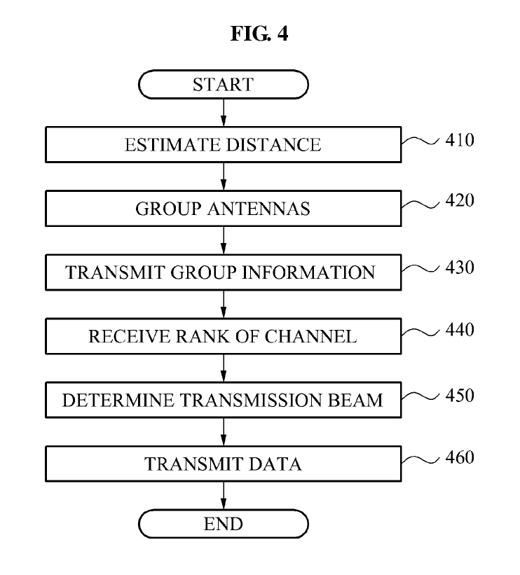

FIG. 4 is a flowchart illustrating an operation method of a transmission apparatus according to an exemplary embodiment.

In operation 410, the transmission apparatus may estimate a distance between the transmission apparatus and a reception apparatus.

In operation 420, the transmission apparatus may select a portion from among a plurality of transmit antennas. The transmission apparatus may inactivate the selected transmit antennas. The transmission apparatus may group unselected transmit antennas into a plurality of transmit antenna groups. The transmission apparatus may select transmit antennas that are adjacent to each other or consecutively aligned, so that the plurality of transmit antenna groups may be physically spaced apart from each other by at least a predetermined distance.

According to an aspect, the transmission apparatus may select a transmit antenna based on a distance between the transmission apparatus and the reception apparatus. The transmission apparatus may determine a distance between the respective transmit antenna groups based on the distance between the transmission apparatus and the reception apparatus, and may select and thereby inactivate transmit antennas that are positioned between the transmit antenna groups. For example, the transmission apparatus may determine the distance between the transmit antenna groups according to Equation 1. The transmission apparatus may group the transmit antennas so that each of the transmit antenna groups may secure a plurality of transmission channels separable from each other.

In operation 430, the transmission apparatus may transmit information about each transmit antenna group, that is, group information to the reception apparatus. According to an aspect, information about each transmit antenna group may include the number of transmit antenna groups and the number of transmit antennas that are included in each transmit antenna group.

According to an aspect, the reception apparatus may include a plurality of receive antennas. The reception apparatus may generate the same number of receive antenna groups as the number of transmit antenna groups based on information about each transmit antenna group. The reception apparatus may transmit information about each receive antenna group to the transmission apparatus. Information about each receive antenna group may include the number of receive antenna groups and the number of receive antennas that are included in each receive antenna group.

In operation 440, the transmission apparatus may receive a rank from the reception apparatus. According to an aspect, the transmission apparatus may transmit a training signal to the reception apparatus. The reception apparatus may estimate a channel formed between the transmission apparatus and the reception apparatus using the training signal. The reception apparatus may generate a channel matrix of the channel between the transmission apparatus and the reception apparatus, and may calculate a rank of the generated channel matrix.

According to an aspect, the rank may be received from the reception apparatus.

In operation 450, the transmission apparatus may determine a transmission beam.

According to an aspect, the transmission apparatus may transmit a training signal using an omni beam or a quasi-omni beam. The omni beam indicates a beam having the same gain with respect to all the directions around the transmission apparatus, and the quasi-omni beam indicates a beam having a formable maximum beam width.

According to an aspect, a Golay sequence and the like may be used as the training signal.

According to an aspect, information about each transmit antenna group may include information about the number of beams that may be formed by the transmission apparatus. The transmission apparatus may transmit a training signal by sequentially forming beams based on the number of formable beams.

The reception apparatus may receive a training signal using a plurality of beams. The reception apparatus may determine an index of a beam used to transmit the strongest training signal and a transmit antenna group that has transmitted the training signal. The reception apparatus may transmit, to the transmission apparatus, information about the index of the beam used to transmit the strongest training signal and the transmit antenna group that has transmitted the training signal. The transmission apparatus may determine an optimal transmission beam using the received index of the beam. The optimal transmission beam may be individually determined with respect to each transmit antenna group.

Similarly, the reception apparatus may determine an optimal reception beam.

In operation 460, the transmission apparatus may transmit data to the reception apparatus. According to an aspect, the transmission apparatus may transmit data using the optimal transmission beam, and the reception apparatus may receive data from the transmission apparatus using the optimal reception beam. When the optimal transmission beam is individually determined with respect to each transmit antenna group, the transmission apparatus may transmit data to the reception apparatus by individually performing beamforming with respect to transmit antennas that are included in each transmit antenna group.

According to an aspect, the transmission apparatus may transmit data based on the rank. In operation 460, the number of data streams to be transmitted by the transmission apparatus may be less than or equal to the rank.

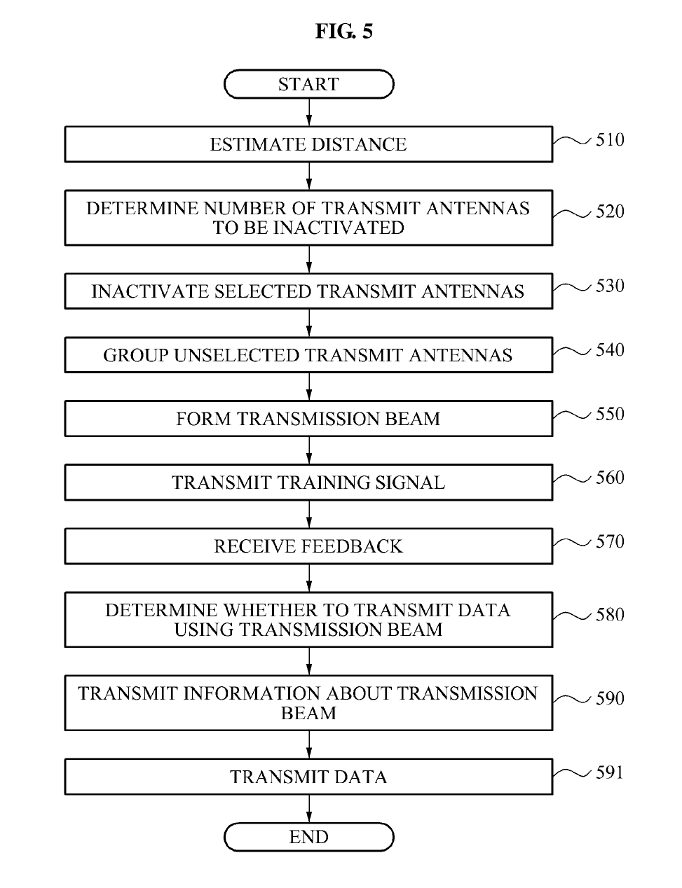

FIG. 5 is a flowchart illustrating an operation method of a transmission apparatus according to another exemplary embodiment.

In operation 510, the transmission apparatus may estimate a distance from the transmission apparatus to a reception apparatus. The transmission apparatus may estimate the distance from the transmission apparatus to the reception apparatus by performing ranging using millimeter wave communication. Also, the transmission apparatus may estimate the distance using a global positioning system (GPS) and the like.

In operation 520, the transmission apparatus may determine the number of antennas to be inactivated based on the estimated distance between the transmission apparatus and the reception apparatus. For example, transmit antennas of the transmission apparatus may be positioned to be spaced apart from each other at intervals corresponding to a half of a wavelength of a carrier frequency to be used to transmit data. Accordingly, the transmission apparatus may determine a distance between the respective transmit antenna groups based on the distance between the transmission apparatus and the reception apparatus, and may determine the number of antennas to be inactivated based on the distance between the transmit antenna groups.

In operation 530, the transmission apparatus may select and inactivate a portion from among the transmit antennas. The transmission apparatus may select and thereby inactivate transmit antennas that are adjacent to each other.

In operation 540, the transmission apparatus may group unselected transmit antennas into a plurality of transmit antenna groups.

In operation 550, the transmission apparatus may form a transmission beam corresponding to each transmit antenna group using transmit antennas that are included in each transmit antenna group.

In operation 560, the transmission apparatus may transmit a training signal to the reception apparatus using the transmission beam. The transmission apparatus may transmit the training signal to the reception apparatus while changing a shape of the transmission beam.

In operation 570, the transmission apparatus may receive a feedback about the training signal from the reception apparatus. According to an aspect, the feedback about the training signal may include information about strength of the received training signal according to a plurality of transmission beams. Also, the feedback about the training signal may include information about a rank of a channel matrix of a channel formed between the transmission apparatus and the reception apparatus.

In operation 580, the transmission apparatus may determine whether to transmit data to the reception apparatus using the transmission beam. According to an aspect, the transmission apparatus may determine whether a plurality of independent transmission channels is formed in a path from the transmission apparatus to the reception apparatus, based on the rank of the channel matrix. When the plurality of independent transmission channels is formed, the transmission apparatus may determine that data is to be transmitted to the reception apparatus using the transmission beam.

In operation 590, the transmission apparatus may transmit, to the reception apparatus, information about the transmission beam to be used to transmit the data. The transmission apparatus may determine a transmission beam used to transmit the strongest training signal as the transmission beam to be used to transmit the data. The transmission apparatus may transmit, to the reception apparatus, information about the transmission beam to be used to transmit data. The reception apparatus may receive information about the transmission beam to be used to transmit the data, and may form the optimal reception beam using information about the transmission beam.

In operation 591, the transmission apparatus may transmit data to the reception apparatus using the determined transmission beam.

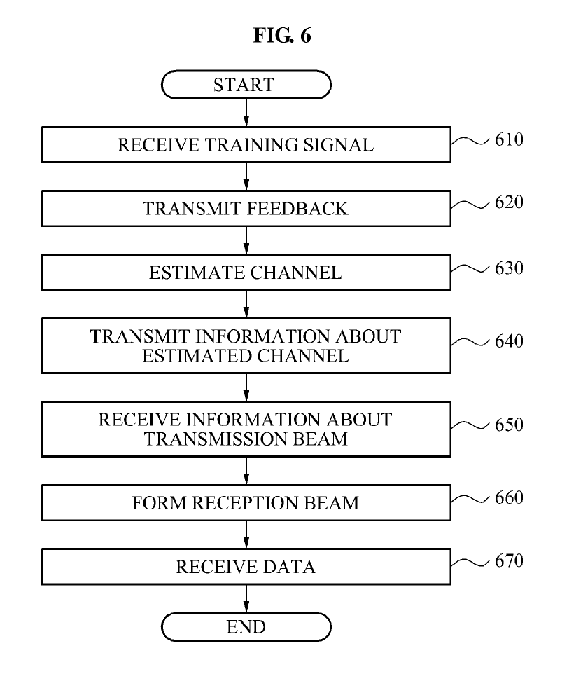

FIG. 6 is a flowchart illustrating a reception method of a reception apparatus according to an exemplary embodiment.

In operation 610, the reception apparatus may receive a training signal from a transmission apparatus. According to an aspect, the transmission apparatus may select a portion from among the plurality of transmit antennas and thereby inactivate the selected transmit antennas. The transmission apparatus may group unselected transmit antennas into a plurality of transmit antenna groups. The transmission apparatus may perform beamforming of the training signal using each transmit antenna group, and may transmit the beam formed training signal to the reception apparatus. The transmission apparatus may transmit the training signal using a plurality of transmission beams.

In operation 620, the reception apparatus may transmit a feedback about the training signal to the transmission apparatus. According to an aspect, the feedback about the training signal may include a strength of the received training signal and information about a transmission beam used to transmit the training signal.

According to an aspect, the transmission apparatus may receive the feedback about the training signal, and may determine the transmission beam to be used to transmit the data to the reception apparatus, based on the feedback.

In operation 630, the reception apparatus may estimate a channel formed between the transmission apparatus and the reception apparatus. According to an aspect, the transmission apparatus may transmit the training signal to the reception apparatus using the determined transmission beam. The reception apparatus may estimate the channel formed between the transmission apparatus and the reception apparatus using the transmitted training signal.

According to an aspect, the reception apparatus may generate a receive antenna group corresponding to each transmit antenna group, and may estimate a channel formed between each transmit antenna group and a corresponding receive antenna group. The reception apparatus may generate a channel matrix using the estimated channel.

In operation 640, the reception apparatus may transmit information about the estimated channel to the transmission apparatus. According to an aspect, information about the channel may include a rank of the channel matrix that is generated using the estimated channel.

In operation 650, the reception apparatus may receive information about a transmission beam from the transmission apparatus. According to an aspect, information about the transmission beam may include the number of transmit antenna groups and the number of transmit antennas that are included in each transmit antenna group. Information about the transmission beam may include information about the transmission beam generated by each transmit antenna group.

In operation 660, the reception apparatus may form a reception beam based on information about the transmit antenna group. According to an aspect, the reception apparatus may generate a receive antenna group corresponding to each transmit antenna group.

In operation 670, the reception apparatus may receive data from the transmission apparatus. According to an aspect, the transmission apparatus may perform beamforming and thereby transmit a data stream using each transmit antenna group. The number of data streams to be transmitted may be less than or equal to a rank of the channel matrix.

According to an aspect, operation 620 may be sequentially performed with respect to each transmit antenna group. For example, when a feedback is initially performed with respect to a first transmit antenna group, a feedback may be performed with respect to a second transmit antenna group.

According to another aspect, operation 620 may be performed in parallel with respect to each transmit antenna group. For example, a feedback with respect to the first transmit antenna group and a feedback with respect to the second transmit antenna group may be simultaneously performed.

The above-described exemplary embodiments of the present invention may be recorded in computer-readable media including program instructions to implement various operations embodied by a computer. The media may also include, alone or in combination with the program instructions, data files, data structures, and the like. The program instructions recorded in the media may be specially designed and be configured for the invention, or may be known to those skilled in the art.

According to exemplary embodiments, it is possible to employ a new spatial multiplexing scheme using beamforming.

Also, according to exemplary embodiments, it is possible to transmit data using interference-free communication channels.

Also, according to exemplary embodiments, it is possible to decode a transmission signal using simple calculation in spatial multiplexing communication.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An operation method of a transmission apparatus, the method comprising:
selecting a portion from among a plurality of activated transmit antennas, inactivating the selected transmit antennas, and grouping unselected activated transmit antennas into a plurality of groups; and
transmitting data to a reception apparatus by individually beamforming each of the plurality of groups.

2. The method of claim 1, further comprising:
to estimating a distance between the transmission apparatus and the reception apparatus,
wherein the grouping comprises selecting the portion from among the plurality of activated transmit antennas based on the distance.

3. The method of claim 1, further comprising:
receiving, from the reception apparatus, a rank of a channel formed between each of the plurality of groups and the reception apparatus,
wherein the transmitting comprises transmitting the data based on the rank.

4. The method of claim 3, wherein the transmitting comprises transmitting, to the reception apparatus, the number of data streams less than or equal to the rank.

5. The method of claim 1, wherein the selected transmit antennas are adjacent to each other.

6. The method of claim 1, further comprising:
transmitting, to the reception apparatus, group information that comprises the number of groups and the number of transmit antennas that are included in each of the plurality of groups,
wherein the transmitting comprises transmitting the data based on the group information.

7. An operation method of a transmission apparatus, the method comprising:
selecting a portion of consecutive transmit antennas from among a plurality of transmit antennas, and inactivating the selected consecutive transmit antennas;
grouping unselected transmit antennas into a plurality of groups; and
to forming a beam corresponding to each of the plurality of groups using transmit antennas that are included in a corresponding group, and transmitting data to a reception apparatus using the formed beam.

8. The method of claim 7, further comprising:
transmitting a training signal to the reception apparatus using the formed beam;
receiving a feedback about the training signal; and
determining whether to transmit the data using the formed beam, based on the feedback.

9. The method of claim 8, further comprising:
transmitting, to the reception apparatus, information about the beam determined to be used to transmit the data, when the data is determined to be transmitted using the formed beam,
wherein information about the beam determined to be used to transmit the data is used to form a reception beam for receiving the data.

10. The method of claim 8, further comprising:
estimating a distance between the transmission apparatus and the reception apparatus; and
determining the number of transmit antennas to be selected based on the distance.

11. An operation method of a reception apparatus, the method comprising:
receiving a training signal that is beam formed and thereby transmitted from each of a plurality of antenna groups, the plurality of antenna groups being generated by inactivating a portion of transmit antennas selected from among a plurality of transmit antennas installed in a transmission apparatus;
transmitting a feedback about the training signal to the transmission apparatus; and
receiving, from the transmission apparatus, data that is transmitted using a transmission beam, the transmission beam being determined based on the feedback.

12. The method of claim 11, wherein the selected transmit antennas are consecutively aligned.

13. The method of claim 11, further comprising:
estimating a channel formed between each of the plurality of antenna groups and the reception apparatus with respect to the transmission beam that is determined based on the feedback; and
transmitting information about the estimated channel to the transmission apparatus,
wherein the receiving comprises receiving the data based on information about the channel.

14. The method of claim 13, wherein:
information about the channel comprises a rank of a channel matrix that is generated using the estimated channel, and
the receiving comprises receiving, from the transmission apparatus, the number of data streams less than or equal to the rank.

15. The method of claim 11, further comprising:
receiving information about the transmission beam that is formed based on the feedback; and
forming a reception beam based on information about the transmission beam,
wherein the receiving comprises receiving the data using the formed reception beam.

16. The method of claim 11, wherein the transmitting is performed in parallel with respect to each of the plurality of antenna groups.

17. The method of claim 11, wherein the transmitting is sequentially performed with respect to each of the plurality of antenna groups.
